(19) United States
(12) Patent Application Publication
(10) Pub. No.: US 2024/0270502 A1
(43) Pub. Date: Aug. 15, 2024

(54) FOOD PROCESSING APPARATUS

(71) Applicant: Mark Dennis Achenbach, Biedenkopf (DE)

(72) Inventor: Mark Dennis Achenbach, Biedenkopf (DE)

(21) Appl. No.: 18/568,130

(22) PCT Filed: Jun. 9, 2021
(86) PCT No.: PCT/EP2021/065453

§ 371 Date: Dec. 7, 2023

(51) Int. Cl. B65G 33/14; A22C 17/00; B65G 33/32

(52) U.S. Cl. CPC B65G 33/14; A22C 17/0026; B65G 33/32; B65G 2201/0202

(57) ABSTRACT

A processing apparatus for food or the like includes a worm for conveying food, and a worm housing including a worm chamber for receiving the worm. The worm housing includes a displacement component which is movable between a closed position in which the displacement component forms part of a boundary of the worm chamber, and an open position in which the displacement component clears access to the worm chamber.

The invention relates to a food processing apparatus and a method of maintaining such an apparatus.

There are various food processing apparatuses which include one or more worm conveyors, the rotation of which transports the foods in a desired direction. This is the case in particular when cutting or chopping apparatuses are involved which chop food such as meat, cheese or fat (so-called “grinders”). In the chopping apparatuses known from DE 10 2018 009 685 B3 and DE 10 2017 003 407 B3, a worm conveyor is rotatably mounted in a cylindrical pressure housing for example. For maintenance, such an apparatus must be disassembled in a relatively complex manner.

Against this background, it was the object of the present invention to provide a food processing apparatus with improved properties, in particular with easier maintainability.

This object is attained by a processing apparatus according to claim 1 and by a method according to claim 15. Advantageous configurations are set forth in the subclaims.

The processing apparatus according to a first embodiment of the invention is intended for processing (for example choppin) foods and the like. It includes the following components:
A device for conveying foods in a desired direction, with the device being hereinafter designated to as “worm”.
A housing having a chamber for receiving the aforementioned worm, which chamber will be designated hereinafter without limitation of generality as “worm housing” and “worm chamber”.

The processing apparatus is characterized in that the worm housing includes at least one moving component, which is referred to hereinafter as “displacement component” and which
forms in a “closed position” part of the boundary of the worm chamber;
clears access in an “open position” to the worm chamber.

Preferably, the displacement component is at least partially connected to the remainder of the worm housing via a seal (against the passage of processed material).

As indicated, the term “worm” is intended to encompass in a broad sense any suitable device for conveying foods, even though a worm in the narrower sense is a preferred embodiment. Such a worm in the narrow sense is formed by a rotatably mounted worm shaft having a worm thread which runs helically on the outside.

The worm chamber of the worm housing generally surrounds the worm relatively closely, so that the food is forced into cavities of the worm and is transported in these cavities when the worm moves. Preferably, the worm is mounted for rotation about an axis relative to the worm housing. Furthermore, the worm housing usually includes an opening through which food can be fed and placed within the effective region of the worm.

The displacement component represents a part of the worm housing which part is movable relative to the remainder of the worm housing, for example by being movably mounted on this remainder. The movement of the displacement component can take place in particular between a closed position, in which the displacement component and the remainder of the worm housing form a functionally complete worm chamber, and at least one open position. In the open position, the displacement component is distanced from the remainder of the worm housing to such an extent as to clear access to the worm chamber. Access to the worm chamber generally ensures also at the same time access to the worm or to a part of the worm. This renders possible maintenance work to be carried out without the worm having to be removed from the worm housing for this purpose (the term “maintenance” being intended to include cleaning in particular).

While the processing apparatus typically serves to process food and accordingly is made of suitable materials (e.g., special steel), it is not limited thereto and may in principle also serve to process other materials. In this sense, the term “food” is to be understood only as representative in the present application.

The displacement component can be movably mounted in particular translatory and/or rotatory relative to the remainder of the worm housing. For example, the displacement component can be connected to the remainder of the worm housing via a hinge joint, so as to be able to move between the closed position and the open position by a pivoting movement about the axis of the hinge joint, with the axis of the pivoting movement being able of lying in particular parallel and/or radially to the worm axis. Likewise, however, translatory mounts are also possible in axial and/or radial direction with respect to the worm. Furthermore, a combination of translatory and rotatory movements can, of course, also be realized.

The displacement component may be a building block of the worm housing, the removal of which leaves a substantially intact remaining worm chamber. In particular, however, the worm housing may also be subdivided into at least two parts in an axial direction (typically the direction of the axis of rotation of the worm), with one of these parts forming the displacement component. In this case, there is usually no longer any intact remainder of the worm chamber in the open position, but the worm chamber is more or less completely open. As a result, particularly good accessibility is, of course, ensured and easy maintenance of the worm chamber as well as the worm is made possible.

According to another refinement, the processing apparatus is constructed in such a way that the worm can be removed from the worm chamber when the displacement component is in the open position. This is intended to involve a removal option that does not exist when the displacement component assumes the closed position. Axial extraction of a conventional worm conveyor from a cylindrical pressure vessel typically represents a removal option for the worm which exists independently of the state of the displacement component, wherein in the embodiment considered here an additional or alternative removal option for the worm is to be added. In particular, such an option may involve a movement of the worm in a radial direction with respect to its axis. The worm typically exits the worm chamber through the region which is assumed by the displacement component in the closed position. In smaller facilities, the worm may be pulled out by hand. In larger facilities, the worm is pushed out of the housing preferably hydraulically, pneumatically or electrically.

According to a refinement of the preceding embodiment, the processing apparatus includes a device for moving the worm to remove it from the worm chamber and/or to insert it into the worm chamber. This device is hereinafter referred to, without limitation of generality, as the “removal device”. The removal device may include, for example, the shaft of a conventional worm conveyor at its axial ends in order to be able to safely raise or lower the entire worm. Movement of the worm relative to the worm chamber with the removal device may hereby be accomplished solely by the use of muscle power of an operator, or optionally also by employing auxiliary power (e.g., electrical power).

According to a refinement of the above embodiment, a movement of the removal device is coupled with the movement of the displacement component, for example by a suitable mechanism. The movement of the displacement component from the closed position to the open position then automatically leads to a conjoint movement of the removal device and thus, for example, to a lifting of the worm from the worm chamber. Preferably, this coupling is such that, after leaving the closed position, a movement of the displacement component alone initially takes place, and only after a certain distance has been covered is a cooperation with the removal device and thus a movement of the worm initiated. In this way, the presence of a space required for the movement of the worm is ensured.

The removal device, via which the worm can be moved relative to the worm chamber, preferably includes at least one bearing of the worm. This means that the worm together with its rotatable mount can be raised with the aid of the removal device. For maintenance of the working area of the worm, there is therefore no need to open or disassemble this mount of the worm.

In the embodiments of the processing apparatus with a removal device, two components are movable relative to the stationary machine frame, namely the displacement component of the worm housing and the removal device or worm. In this context, the removal device is preferably designed such as to be supported (at least in the closed state of the worm housing) in axial direction and/or radial direction on the worm housing and/or the machine frame. Since the worm is exposed in particular to high axial forces during the processing of material, a coupling of the removal device with at least one part of the worm housing in axial direction is important above all in order to prevent relative movements from occurring during operation. In particular, at least one bearing of the worm, which absorbs axial forces, can be coupled in axial direction to a part of the worm housing in order to neutralize potential axial forces.

In a refinement of the afore-described embodiment, the removal device preferably engages the displacement component, the remainder of the worm housing and/or the machine frame via fits in order to ensure good positioning of the worm in the worm chamber (an accuracy of one tenth of a millimeter is not unusual in this respect). A fit in this context is usually understood to relate to the form-fitting connection of two parts (e.g. tongue-and-groove connection), which is formed with small tolerances, with the two parts typically engaging in each other with the same nominal dimension.

In a preferred embodiment of the processing apparatus with a removal device, the displacement component and the removal device are rotatably mounted on a common shaft. In this way, a particularly stable and simple structure can be attained. In addition or as an alternative, a slidably moving mount can also be established on a common shaft or a common carrier.

It has already been mentioned that the processing apparatus can serve in particular for chopping foods or the like. According to a preferred embodiment, it therefore includes cutting means for chopping material conveyed by the worm. Such cutting means can be formed, for example, by a cutting drum cylindrically surrounding the worm (cf. DE 10 2018 009 685 B3), a cutting edge on the conveying worm (cf. DE 10 2017 003 407 B3) or cutting edges on an axial end or lateral branch of the processing apparatus.

The worm is usually mounted for rotation relative to the worm housing. In particular, it can be mounted in a main bearing, which is located in a portion that lies upstream of the working area of the worm, as seen in the conveying direction of the worm. The “conveying direction” refers hereby to the direction in which the worm transports material during its intended rotational movement, and the “working area” refers to the area in which the worm comes into contact with the processed material. The main bearing is preferably designed in such a way that it accommodates the worm in a self-supporting manner, i.e. no further bearing is required for the balanced mounting of the worm. In addition or as an alternative, it is designed to absorb axial forces acting on the worm. Preferably, it is the only bearing on the worm that absorbs the axial forces.

Furthermore, the worm can optionally be mounted in a centering bearing, which is located in a portion of the worm downstream or in its working area, as seen in the conveying direction of the worm. The centering bearing is preferably located exactly at the opposite end of the working area of the worm with respect to the aforementioned main bearing. In particular, the centering bearing may receive one end of the worm. According to a preferred configuration, the centering bearing is formed as a rolling bearing, for example with the aid of suitable ball bearings. The centering bearing is generally designed to center the worm radially with respect to the worm chamber, and less so to absorb high forces.

The explained main bearing and/or the centering bearing is preferably a part of the removal device according to the afore-described embodiments.

According to another refinement of the invention, the worm has a pin at one end (preferably its end lying in the conveying direction), with the end of the pin being mounted in a bearing, preferably a rolling bearing. This bearing may involve in particular a centering bearing of the type described above. Furthermore, the pin may optionally have form elements such as, for example, threads (outer helix) for conveying and/or cutting foods on its outer surface that is not located in the bearing. The complete pin may optionally be exchangeably connected to the worm (e.g., via a screw connection), or it may be formed in one piece with the worm. By means of a completely exchangeable pin, it is possible in a simple manner to form the end of the worm in different ways for different processing purposes.

When the pin includes form elements (e.g. threads) on its outer surface, it is preferably designed in such a way that these continuously (without offset) adjoin and continue form elements of the actual worm.

In addition or as an alternative, the pin can be formed in two parts from an exchangeable pin sleeve and a pin core, with the pin sleeve carrying possible external form elements. In this way, various pin configurations can be flexibly produced. Typically, the pin sleeve is connected in fixed rotative engagement with the pin core, in particular in such a way that it can only be fitted in a specific angular configuration.

Processing of material usually takes place in the worm chamber under high pressure (typical values are at 40 bar). The connection between the displacement component and the remainder of the worm housing must therefore be suitably well sealed so that no material can escape. In a preferred embodiment, a main seal and an auxiliary seal are arranged for this purpose between the displacement component and the remainder of the worm housing, with the main seal preferably being located upstream of the auxiliary seal, as seen in the direction of flow of material exiting the worm chamber.

The main seal can be formed, for example, by surfaces lying flat on each other on the displacement component and on the remainder of the worm housing. Such surfaces are typically polished and pressed together under high pressure.

The auxiliary seal can be formed, for example, by an elastic sealing element of plastic or rubber, which is compressed to a greater or lesser extent when the displacement component and the remainder of the worm housing are connected.

According to a refinement of the afore-described embodiments, (at least) an offset (jump) is formed between the main seal and the auxiliary seal. Material exiting the worm chamber would therefore first have to overcome this offset and change its flow direction one time or more times, so that such an exit becomes more difficult. The offset can be created, for example, by a protruding sealing element engaging in a groove on the opposite component.

According to another embodiment, a seal and a relief channel are formed between the displacement component and the remainder of the worm housing, with the seal preferably being located upstream of the relief channel, as seen in the direction of flow of material exiting the worm chamber. The relief channel is hereby open towards a region of the worm chamber. This region of the worm chamber involves preferably a zone in which material to be processed is not under increased pressure. This can be, for example, the feed zone of the worm chamber. The seal can in particular be the afore-described main seal, with the relief channel being then preferably arranged between the main seal and the auxiliary seal.

The worm chamber may have, at least in some areas (locally), a wall structure cooperating with the worm. This may optionally involve cavities milled into the wall of the worm chamber, for example in the form of a thread. The cooperation of the typically rotatable worm with the fixed wall structure can advantageously assist the transport and/or a chopping of foods. As a result of the good accessibility of the worm chamber, it is possible to maintain the wall structure and, for example, to clean it regularly.

According to a second aspect, which has independent significance, the invention includes a processing apparatus for food and the like, comprising the following components:
A worm for conveying foods in a desired direction (“conveying direction”).
A worm housing having a worm chamber for receiving the afore-mentioned worm.

The processing apparatus is characterized in that the inner wall includes an exchangeable portion, i.e. a portion which can be exchanged for another portion if need be. In this way, the geometry and/or structure of the inner wall can be modified in a simple manner and adapted to a processing purpose. For example, a smooth inner wall can be exchanged for an inner wall provided with depressions that run circumferentially in a helical manner. In particular, the exchangeable portion can have the shape of a half shell.

Furthermore, a processing apparatus may preferably have features according to both the first aspect and the second aspect of the invention.

According to a further aspect, an embodiment of the present invention relates to a method for maintaining a processing apparatus for food or the like having a worm housing with a worm mounted therein. The method is characterized in that a displacement component of the worm housing is moved to an open position in which it clears access to the worm chamber.

The method can be carried out in particular with a processing apparatus according to one of the afore-described embodiments. The features of the invention described with respect to the processing apparatus can thus also be applied analogously to the method and vice versa.

In the following, an exemplary embodiment of the invention is explained in more detail with reference to the figures. It is shown hereby in:

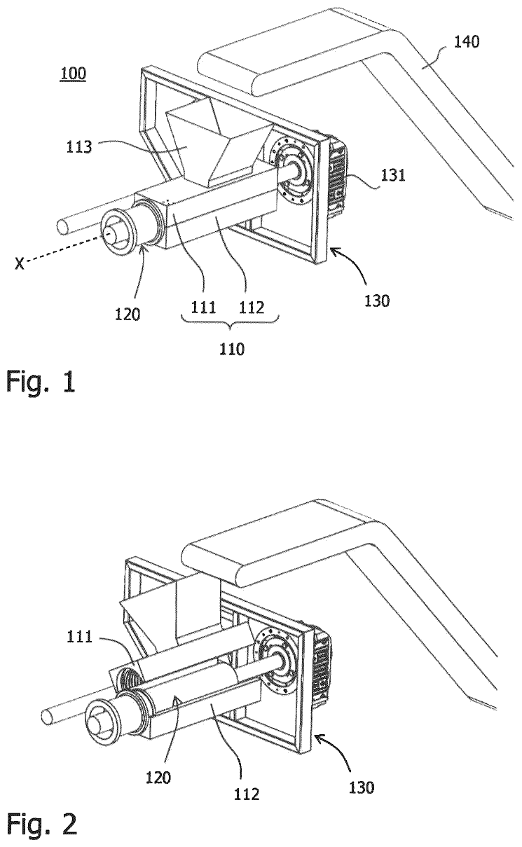

FIG. 1 a perspective view of essential parts of a processing apparatus according to a first embodiment of the invention, with the displacement component being in the closed position;

FIG. 2 the processing apparatus of FIG. 1 with the displacement component halfway to the open position;

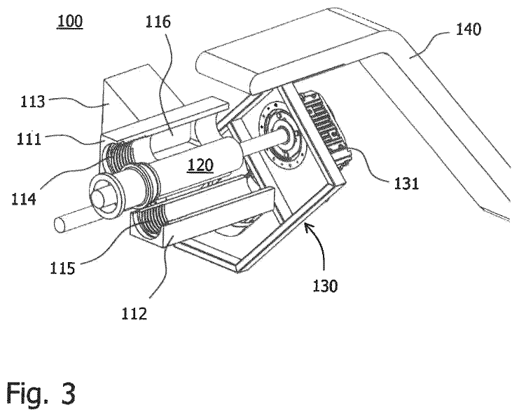

FIG. 3 the processing apparatus of FIGS. 1 and 2 with the displacement component in the open position and with raised worm conveyor;

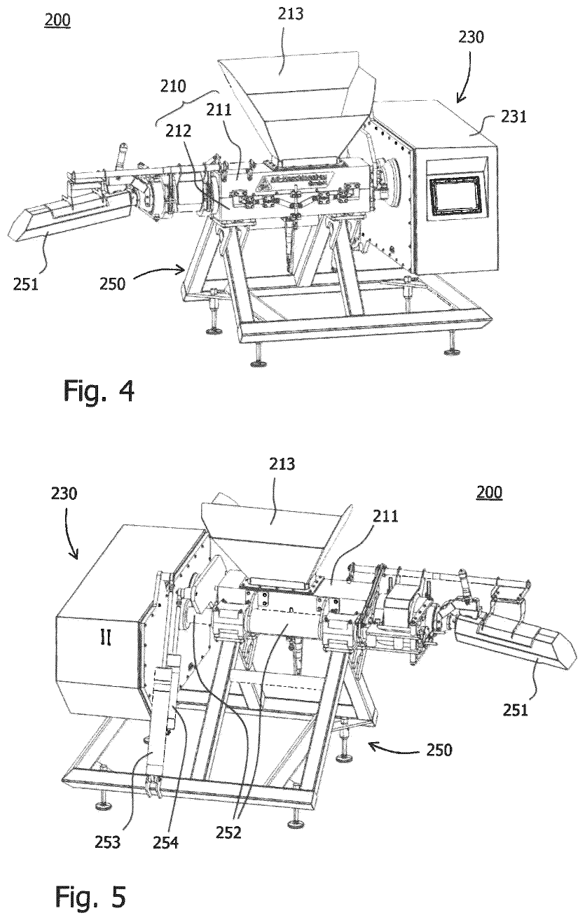

FIG. 4 a perspective view of a processing apparatus according to a second embodiment of the invention, with a view onto the opening side of the worm housing (front side), with the displacement component assuming the closed position;

FIG. 5 a perspective view of the processing apparatus of FIG. 4 looking at the rear side;

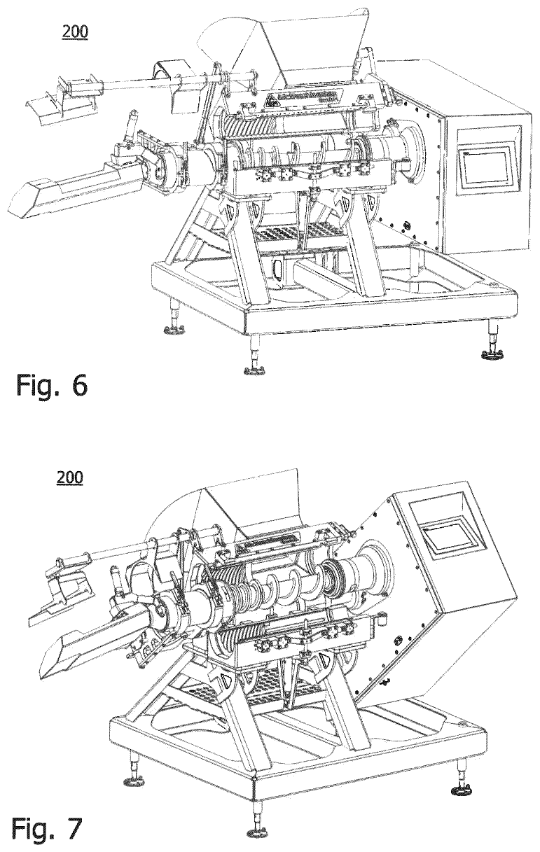

FIG. 6 shows the processing apparatus of FIGS. 4 and 5 with the displacement component halfway to the open position;

FIG. 7 shows the processing equipment of FIGS. 4 to 6 with the displacement component in the open position and with raised worm conveyor;

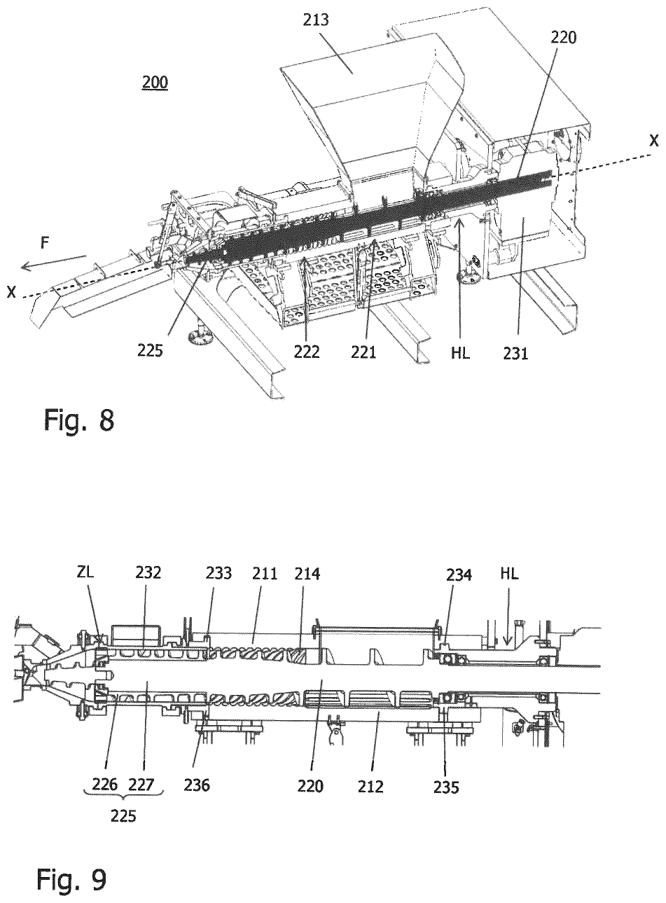

FIG. 8 a perspective sectional view of the processing apparatus of FIG. 4 along the worm;

FIG. 9 an enlarged side view of the section of FIG. 8;

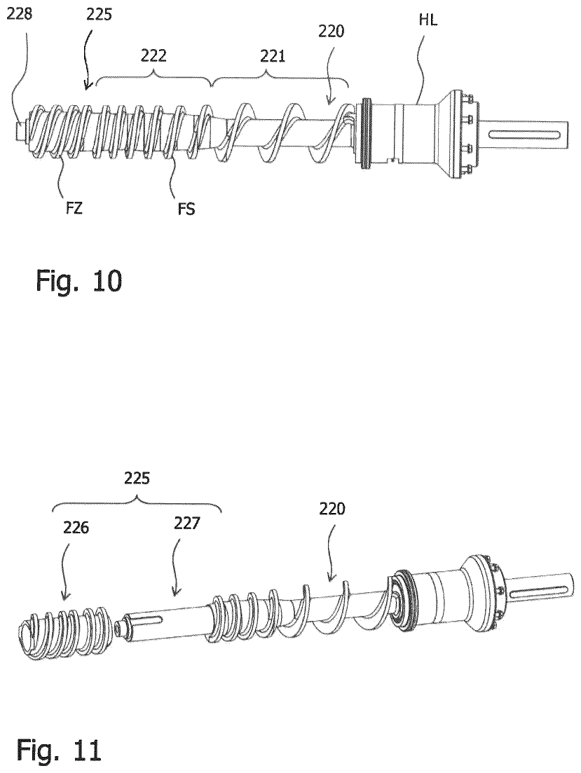

FIG. 10 a worm with pin and main bearing;

FIG. 11 the worm of FIG. 10 with the pin sleeve loosened;

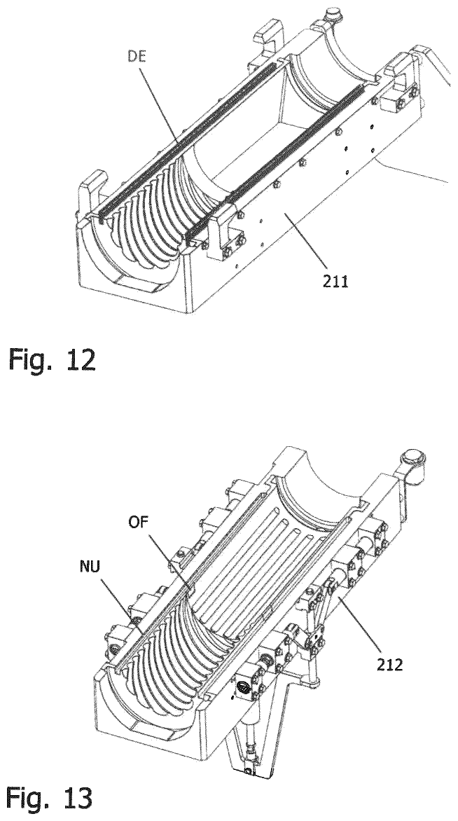

FIG. 12 a view of the inner wall of the top shell;

FIG. 13 a view of the inner wall of the bottom shell;

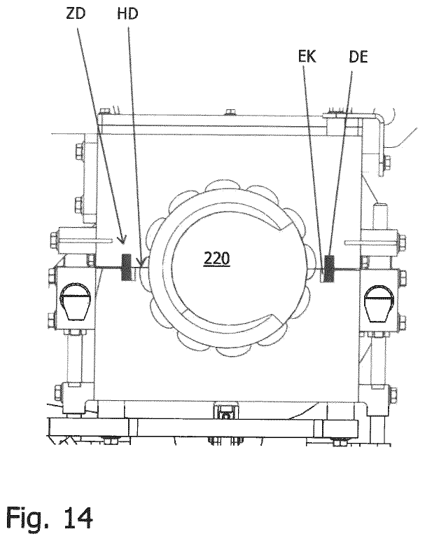

FIG. 14 a cross-section through the closed worm housing;

FIG. 16 a view of an exchangeable portion of the bottom shell.

FIG. 1 shows a perspective view of essential components of an exemplary food processing apparatus 100, in this case a meat grinder for chopping meat pieces. Parts not relevant to the present invention, such as a surrounding machine housing, are omitted from the drawings for sake of clarity.

The processing apparatus 100 includes a feed hopper 113 into which food (not shown) transported thereto via a conveyor belt 140 can be fed from above. The feed hopper 113 is located at the top of a cuboidal worm housing 110, which is composed of a top shell 111 and a bottom shell 112, which divide the worm housing substantially in half in the direction of the axis X.

The top shell 111 and the bottom shell 112 of the worm housing together form an essentially cylindrical worm chamber in which a worm conveyor 120 is mounted for rotation about the axis X. The shaft of the worm conveyor 120 is hereby connected to an electric motor 131 so as to cause rotation thereof relative to the worm housing 110. Due to a design of the worm 120, which is not shown in more detail here, with, for example, helically running worm threads, material fed into the feed hopper 113 can be transported when the worm rotates in the conveying direction (to the left in FIG. 1). As a result of the transport and a pressure build-up, the food can be cut by cutting means which are also not shown in more detail here, with the food thus leaving the processing apparatus chopped.

FIG. 1 shows the processing apparatus 100 in its working state, in which the top shell 111 is firmly connected to the bottom shell 112 of the cutter housing 110, i.e. the top shell 111 is in the so-called “closed position”. However, for maintenance purposes, for example cleaning of the worm conveyor and the worm chamber, the top shell 111 and bottom shell 112 can be folded apart as explained hereinafter.

FIG. 2 shows in this respect an intermediate step of unfolding, in which the top shell 111 has been pivoted a short distance about a hinge joint extending in axial direction and has thus left its closed position, in which it is connected to the bottom shell 112 and forms a cutting chamber. The top shell 111 thus represents a movably mounted “displacement component”, while the bottom shell 112 is typically fixed to the remainder of the machine frame and remains stationary.

The position of the top shell 111 shown in FIG. 2 may already be considered an “open position”, since it already clears access to the worm chamber and the worm conveyor 120.

For even better accessibility of the worm chamber and worm conveyor, the top shell 111 can preferably be pivoted however even further, for example into the open position shown in FIG. 3. In this position, the top shell 111 is folded to the side by about 90° relative to its closed position and optionally also in addition translatorily displaced (or completely detached from the remainder of the worm housing).

It is additionally apparent from FIG. 3 that the worm 120 is raised from its working position so that it can be particularly well cleaned, repaired or replaced. For this purpose, the worm conveyor 120 is located on a removal device 130, which when moved carries the worm along. In the embodiment shown here only in principle, the removal device 130 is formed, for example, by a frame to which the electric motor 131 for rotatably driving the worm is also attached and which can be pivoted about an axis parallel to the axis of rotation X of the worm.

The movements of the top shell 111 and the removal device 130 can be independent of one another, so that, for example, the top shell 111 can be brought into the open position first or alone and then, if need be, the worm 120 can be raised out of the worm chamber or lowered into the worm chamber with the removal device. Preferably, however, provision is made for a mechanical and/or electrical coupling between the movement of the top shell 111 and the movement of the removal device 130, so that when the top shell 111 reaches the final open position, the worm conveyor 120 is also simultaneously lifted out of the worm chamber, as shown in FIG. 3. In particular, for this purpose, the first part of the opening path of the top part 111 (e.g. the path from the closed position according to FIG. 1 to the intermediate position according to FIG. 2) can take place without carrying along the removal device 130. Only during transition from the intermediate position (FIG. 2) to the open position according to FIG. 3 is the removal device 130 being carried along.

Unfolding of the worm housing 110 and/or movement of the removal device 130 can be generated by muscle power alone or optionally by use of auxiliary power, for example the drive of electric motors.

In FIG. 3, the inner surfaces of the cutting chamber are visible. A feed opening 116 of the feed hopper 113 is hearby visible, through which food can enter the worm chamber. Furthermore, milled, typically helically extending, grooves 114, 115 are indicated in the top shell and bottom shell, respectively, which cooperate with the worm 120 for the transport and/or chopping of food. The worm 120 itself is shown in simplified form in the figures as a smooth cylinder, although it typically has helically running worm threads.

While the figures show a pivoting of the displacement component 111 about an axis parallel to the worm axis, other movements are also possible, such as turning away and/or pushing away in axial direction.

In summary, FIGS. 1 to 3 show a food processing apparatus 100 such as a meat grinder for example. According to a preferred embodiment, the processing apparatus 100 includes a rotatable worm 120 which is mounted in the worm chamber of a worm housing. The worm housing is formed by a stationary component 112 and a displacement component 111, which can be moved apart to clear access to the worm chamber. Furthermore, the worm 120 can preferably be lifted from the worm chamber by a removal device 130.

FIGS. 4 to 15 illustrate a processing apparatus 200 according to a second embodiment. In this embodiment, the principles of the first processing apparatus 100 explained above are realized and supplemented by further specific design elements, which are explained in more detail hereinafter.

In the external views of FIGS. 4 to 7, the entire processing apparatus 200 can be seen, which in particular includes
a stationary machine frame 250 with the bottom shell 212, wherein the rods of the machine frame are preferably formed without closed cavities (i.e., e.g., solid or as open angles).
the moving top shell 211,
the feed hopper 213 connected to the top shell,
a chute 251 connected to the machine frame 250, and
a removal device 230 movable relative to the machine frame and including an electric motor 231 for driving the worm 220 (not visible in FIGS. 4 and 5).

In the view onto the rear side of the processing apparatus 200 in FIG. 5, a shaft 252 can be seen in particular, with respect to which on the one hand the top shell 211 with the hopper 213 and on the other hand the removal device 230 are rotatably mounted relative to the machine frame 250. Furthermore, a lid of the chute 251 and possibly other parts are attached to the top shell 211 via a linkage, so that the chute 251 is automatically opened when the top shell is moved.

The top shell 211 is pivoted from the closed position (FIG. 4) to a raised position of about 45° (FIG. 6) by a first pneumatic cylinder 254 between the top shell and the removal device 230 (motor housing). Further pivoting of the top shell 211 together with the removal device 230 (FIG. 7) is effected via a second pneumatic cylinder 253 between the machine frame 250 and the removal device 230. In other words, the first pneumatic cylinder 254 moves the top shell 211 relative to the removal device 230 with the worm 220, and the second pneumatic cylinder 253 connected in series with it moves the removal device with the worm (and thus also the top shell) relative to the machine frame 250.

FIGS. 6 and 7 show the processing apparatus 200 with the worm housing partially opened by the pneumatic cylinder 254 (FIG. 6) and with the worm housing fully opened by the pneumatic cylinder 253 and with the worm additionally lifted, including its bearings (FIG. 7).

FIGS. 8 and 9 show a section along the axis X of the worm 220 (the section area of the worm is shown in black in FIG. 8 for better visibility). The threads on the outside of the worm and the typical direction of rotation of the worm indicate a conveying direction F in which material filled into the hopper 213 is transported.

At its front end in conveying direction F, the worm 220 is coupled to the electric motor 231 of the removal device 230. Downstream of this, the worm is mounted in a main bearing HL so that it can rotate and is self-supporting. The main bearing is firmly connected to the removal device 230 or the housing of the electric motor 231.

The working area of the worm, i.e. the area in which it can come into contact with foods and process them, commences downstream of the main bearing HL in the conveying direction F. In a transport portion 221, provision is made for threads with a relatively large increase and large gaps to transport the filled material only in conveying direction F.

Adjacent thereto is a chopping portion 222, in which the material is compacted and, in cooperation with a helical wall structure 214, also chopped under increased pressure.

This area is then adjoined by a pin 225, which extends the worm in the conveying direction F. In an optional embodiment, the pin can be replaceable as a whole, for example by being screwed into the head end of the worm 220, wherein other tools (e.g. a cutting edge) can optionally be attached to the screw thread of the worm. In the example shown, the pin 225 is formed in one piece with the worm (i.e., part of the worm).

The pin 225 is mounted at its front end in a centering bearing ZL, which is designed as a rolling bearing. In the intermediate region of the pin 225, its outer side is provided with threads. This region is arranged in a pin chamber 232, which may be of various configurations and may be replaceable. For example, the pin chamber 232 can have a perforated wall through which material can escape.

With the aid of the centering bearing ZL, it is possible to position the worm 220 precisely centered within the worm chamber despite its arrangement in a movable removal device.

During operation of the processing apparatus 200, high axial forces are generated by the axial pressure of the material to be conveyed. In the example shown, the main bearing HL absorbs these forces from the worm and passes them onto the worm housing through its form fit. This means that when the system is closed (worm, main bearing, worm housing) and the drive is switched on, no axial forces occur outside this system.

For the reasons explained above and in order to be able to maintain the close distance tolerances between the worm 220 and the surrounding worm chamber, form-fitting couplings are preferably provided between the movable bearings HL, ZL of the worm and the bottom shell 212 (as part of the machine frame 250) or the top shell 211, as shown in FIG. 9.

In this way, the top shell 211 cooperates, with the pin chamber 232 or the centering bearing ZL connected thereto via a fit 233 in particular. In a similar manner, the top shell 211 interacts with the main bearing HL via a further fit 234. For example, in the example shown, a groove formed on the top shell 211 and a tongue formed on the centering bearing ZL or the main bearing HL have the same nominal dimension. Furthermore, the pin chamber 232 or the centering bearing ZL engage in the bottom shell 212 via a fit 236, and the main bearing HL engages in the bottom shell 212 via a fit 235. In this way, exact positioning of the worm 220 and its bearings relative to the worm housing is ensured. Furthermore, all axial forces transmitted from the worm 220 to the main bearing HL are transferred onto the worm housing 211, 212, so that no relative displacements can occur between the worm and the worm housing in axial direction.

A preferred configuration of the worm 220 and the pin 225 is again shown separately in FIGS. 10 and 11. As is apparent from FIG. 10, the threads FZ (forming elements) on the outer side of the pin 225 are formed in such a way that they continue the threads FS on the outer side of the worm 220 continuously and without offset (Jump). Furthermore, at its end lying in the conveying direction, the pin 225 has a bearing shoulder 228 which is received in a rolling bearing to form the centering bearing ZL.

FIG. 11 shows how the pin 225 can optionally include a pin core 227 and a pin sleeve 226 pushed over it, which can preferably only be assembled in a certain relative angular position. The exchangeable pin sleeve enables easy adjustments to accommodate different modes of operation of the processing apparatus.

During operation of the processing apparatus 200, there is a risk that the material under high pressure will leak between top shell 211 and bottom shell 212. To prevent this, provision is made for the two-stage sealing mechanism shown in FIGS. 12 to 14. This includes a main seal HD and an auxiliary seal ZD, which are arranged behind one another in this sequence as viewed in the potential flow direction of the material.

In the example shown, the main seal HD includes smoothly polished sealing surfaces at which the top shell 211 and the bottom shell 212 rest on each other under highest possible pressure.

In addition, an elongated sealing element DE of plastic or rubber is firmly arranged in the top shell 211 parallel to both sealing surfaces as an auxiliary seal ZD and projects beyond the plane of the sealing surface of the main seal HD. In the closed state of the worm housing, the projecting part engages in a complementary groove NU of the bottom shell 212. Optionally, the sealing element DE could, of course, also be formed on the bottom shell and the groove on the top shell. The additional groove NU or the elastic sealing element DE behind the main seal HD provides an auxiliary sealing barrier.

Furthermore, a relief channel EK is preferably provided between the main seal HD and the auxiliary seal ZD and is open at another point (in the example shown at the openings OF) to an inner region of the worm chamber. In particular, this can involve a zone which is located in the transport portion 221 at the feed hopper 213 and in which material is present without overpressure. The relief channel EK can be formed in particular such that the groove NU is correspondingly widened on the side of the main seal HD. Should material be able to pass through the main seal during operation, it will enter the relief channel EK and then is directed back into the worm chamber along the sealing element DE.

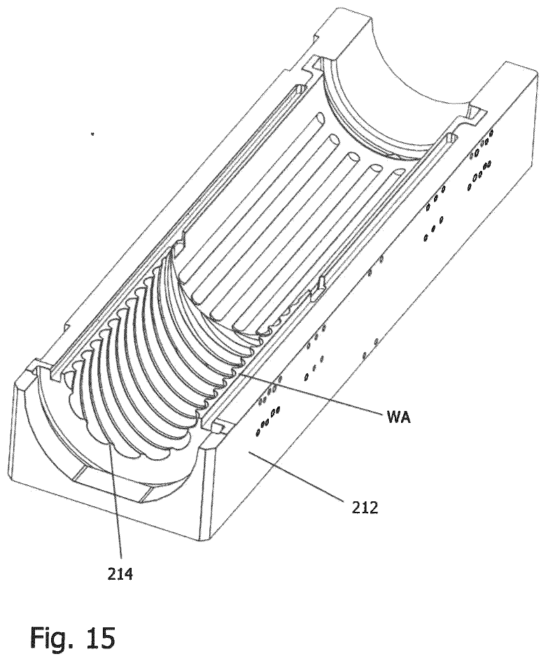

FIG. 15 illustrates a further optional design variant of the processing apparatus 200. Provision is hereby made for a half-shell-shaped exchangeable portion WA in the bottom shell 212 as part of the inner wall. In the example shown, this exchangeable portion WA has helically running wall structures 214. By means of such an easily replaceable exchangeable portion WA, it is possible to flexibly adapt the wall structure in the worm chamber to the respective requirements in a simple manner. A similar exchangeable portion is of course preferably also formed on the top shell 211. In the case of a worm chamber that cannot be opened or cannot be opened completely, the exchangeable portion could also be 360° circumferentially cylindrical, for example.

### LIST OF REFERENCE SIGNS

| | | | |
|---|---|---|---|
| 100, 200 | processing device | HL | main bearing |
| 110, 210 | worm housing | ZL | centering bearing |
| 111, 211 | top shell | HD | main seal |
| 112, 212 | bottom shell | ZD | auxiliary seal |
| 113, 213 | feed hopper | EN | sealing element |
| 114, 115, 214 | wall structures | NU | groove |
| 116 | feed opening | EK | relief channel |
| 120, 220 | worm | WA | exchangeable portion |
| 221 | transport portion | FZ | form element (pin) |
| 222 | chopping portion | FS | form element (worm) |
| 225 | pin | X | worm axis |
| 226 | pin sleeve | OF | opening |
| 227 | pin core | | |
| 228 | bearing shoulder | | |
| 130, 230 | removal device | | |
| 131, 231 | electric motor | | |
| 232 | pin chamber | | |
| 233-236 | fit | | |
| 140 | conveyor belt | | |
| 250 | machine frame | | |
| 251 | chute | | |
| 252 | shaft | | |
| 253, 254 | pneumatic cylinder | | |

1.-16. (canceled)

17. A processing apparatus for food or the like, comprising:
a worm for conveying food; and
a worm housing including a worm chamber for receiving the worm, said worm housing including a displacement component movable between a closed position in which the displacement component forms part of a boundary of the worm chamber, and an open position in which the displacement component clears access to the worm chamber.

18. The processing device of claim 17, wherein the worm housing is subdivided in an axial direction into at least two parts, with one of the at least two parts forming the displacement component.

19. The processing device of claim 17, further comprising a removal device designed to move the worm into and/or out of the worm chamber.

20. The processing device of claim 19, wherein the removal device includes at least one bearing in which the worm is mounted.

21. The processing device of claim 19, wherein the removal device is supported on the worm housing in an axial direction and/or radial direction.

22. The processing device of claim 19, further comprising a shaft, said displacement component and said removal device being rotatably and/or displaceably mounted on the shaft.

23. The processing device of claim 17, wherein the worm has a working area in which the worm comes into contact with the food to process it, and further comprising a main bearing designed to support the worm in a portion located in a conveying direction of the worm upstream of the working area.

24. The processing device of claim 17, wherein the worm has a working area in which the worm comes into contact with the food to process it, and further comprising a centering bearing designed to support the worm in a portion located in a conveying direction of the worm in or downstream of the working area.

25. The processing device of claim 17, further comprising a rolling bearing, said worm includes at one end a pin having an end which is supported in the rolling bearing.

26. The processing device of claim 25, wherein the pin includes on its outer side forming elements which continue forming elements of the worm.

27. The processing device of claim 25, wherein the pin includes an exchangeable pin sleeve.

28. The processing device of claim 17, further comprising a main seal and an auxiliary seal arranged between the displacement component and a remainder of the worm housing.

29. The processing device of claim 28, wherein the main seal is located upstream of the auxiliary seal as viewed in a flow direction out of the worm chamber.

30. The processing device of claim 28, wherein an offset is formed between the main seal and the auxiliary seal.

31. The processing device of claim 17, further comprising a seal and a relief channel which are formed between the displacement component and a remainder of the worm housing, with the relief channel being open to a region of the worm chamber.

32. A processing device for food or the like, comprising:
a worm for conveying food;
a worm housing including a worm chamber for receiving the worm, said worm chamber including an inner wall; and
an exchangeable portion forming part of the inner wall of the worm chamber.

33. A method for maintaining a processing apparatus for food or the like, which comprises a worm housing with a worm mounted therein, the method comprising moving a displacement component of the worm housing to an open position in which the displacement component clears access to the worm.

34. The method of claim 33, further comprising moving the worm into and/or out of the worm chamber by a removal device.

35. The method of claim 34, further comprising rotatably and/or displaceably mounting the displacement component and the removal device on a common shaft.

36. The method of claim 33, further comprising moving the displacement component to a closed position in which the displacement component forms part of a boundary of a worm chamber of the worm housing.
